(19) United States
(12) Patent Application Publication
(10) Pub. No.: US 2006/0107056 A1
(43) Pub. Date: May 18, 2006

(54) Techniques to manage digital media

(76) Inventors: Dhiraj Bhatt, Portland, OR (US); Raja Neogi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/992,394

(22) Filed: Nov. 17, 2004

(51) Int. Cl. H04L 9/00

(52) U.S. Cl. 713/176

(57) ABSTRACT

Method and apparatus to manage digital media using watermarking and fingerprinting techniques are described.

### BACKGROUND

A communication system may facilitate the transfer of information, including proprietary information such as movies, videos and music. Consequently, security techniques have been developed to protect such proprietary information. Improvements in security techniques may provide greater control over distribution of proprietary information using a communication system.

### BRIEF DESCRIPTION OF THE DRAWINGS

FIG. 1 illustrates a block diagram of a system 100.

FIG. 2 illustrates a block diagram of a security management module 108.

FIG. 3 illustrates a programming logic 300.

FIG. 4 illustrates a programming logic 400.

### DETAILED DESCRIPTION

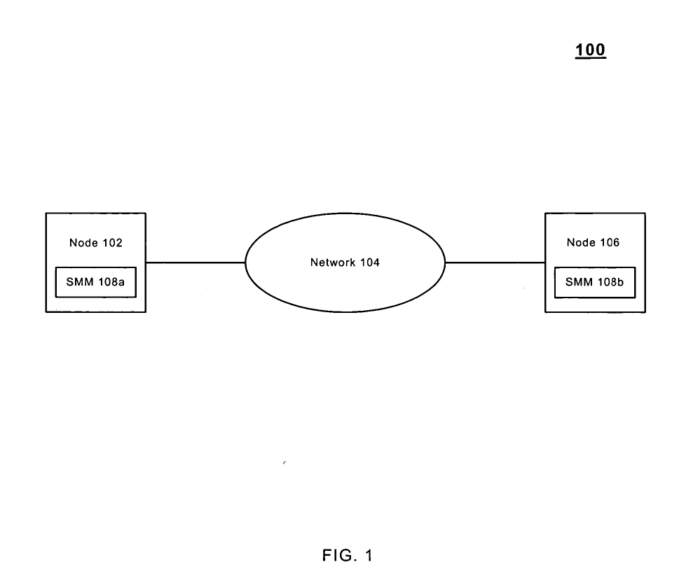

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, handheld device, mobile telephone, personal digital assistant, router, switch, bridge, hub, gateway, wireless access point, and so forth. The unique address may comprise, for example, a network address such as an Internet Protocol (IP) address, a device address such as a Media Access Control (MAC) address, and so forth. The embodiments are not limited in this context.

The nodes of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may operate in accordance with one or more Internet protocols.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, system 100 may include one or more wireless nodes arranged to communicate information over one or more types of wireless communication media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), amplifiers, filters, control logic, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, and so forth. The embodiments are not limited in this context.

Referring again to FIG. 1, system 100 may comprise nodes 102 and 106 connected by a network 104. Although FIG. 1 is shown with a limited number of nodes in a certain topology, it may be appreciated that system 100 may include more or less nodes in any type of topology as desired for a given implementation. The embodiments are not limited in this context.

In one embodiment, system 100 may include nodes 102 and 106. Nodes 102 and 106 may comprise any nodes arranged to transmit or receive media information as previously described. The media information may include audio information, video information, or a combination of audio/video information. Examples of audio information may include music, songs, speech, and so forth. Examples of video information may include movies, videos, graphics, images, alphanumeric symbols, and so forth. The embodiments are not limited in this context.

In one embodiment, for example, node 102 may comprise a content server having a database of audio information, video information, or a combination of audio/video information. For example, content server 102 may include a video on demand (VOD) or music on demand (MOD) server having a database of movies and songs, respectively. Alternatively, content server 102 may be implemented as part of a television broadcast distribution source, a cable distribution source, a satellite distribution source, and other network sources capable of providing audio information, video information, or a combination of audio/video information. The embodiments are not limited in this context.

In one embodiment, for example, node 106 may comprise a client device to access the media information stored by content server 102. Examples of client devices may include any devices having a processing system, such as a computer, a personal digital assistant, set top box, cellular telephone, video receiver, audio receiver, and so forth. The embodiments are not limited in this context.

Content server 102 may communicate the media information to client device 106 via network 104 in accordance with any number of audio and video standards. For example, a movie or video may be compressed or encoded using one or more techniques in accordance with the Motion Picture Experts Group (MPEG) series of standards as defined by the International Organization for Standardization/International Electrotechnical Commission (ISO/IEC). Although some embodiments may be illustrated using the MPEG series of standards by way of example, however, it may be appreciated that any number of video and/or audio encoding techniques may be used and still fall within the scope of the embodiments. The embodiments are not limited in this context.

In one embodiment, system 100 may include network 104. Network 104 may comprise any type of network arranged to communicate information between the various nodes of system 100. For example, network 104 may comprise a packet or circuit-switched network, such as a Local Area Network (LAN) or Wide Area Network (WAN), a Public Switched Telephone Network (PSTN), a wireless network such as cellular telephone network or satellite network, or any combination thereof. Network 104 may communicate information in accordance with any number of different data communication protocols, such as one or more Ethernet protocols, one or more Internet protocols such as the Transport Control Protocol (TCP) Internet Protocol (IP), Wireless Access Protocol (WAP), and so forth. The embodiments are not limited in this context.

In one embodiment, nodes 102 and 106 may also include elements 108a and 108b, respectively. Element 108 may comprise, for example, a security management module (SMM) 108. SMM 108 may manage security operations on behalf of a node. More particularly, SMM 108 may be arranged to use certain “fingerprint” and “watermark” techniques to control ownership and distribution of the media information. In one embodiment, for example, SMM 108 may use a combination of fingerprint and watermark techniques in a dynamic manner to increase control over the distribution of the media information.

In general operation, system 100 may be used to transfer information, including proprietary information such as movies, videos, music and so forth. As a result, security techniques may be needed to protect such proprietary information. Such security techniques are typically categorized into two general groups, that is, copy protection and ownership protection. Copy protection attempts to find ways which limit access to copyrighted material and/or inhibit the copy process itself. Examples of copy protection may include various encryption techniques, such as encrypting a digital TV broadcast, providing access controls to copyrighted software through the use of license servers, and technical copy protection mechanisms on the media (e.g., a compact disc or digital versatile disc). Ownership protection, on the other hand, attempts to associate ownership information with the digital object, such as inserting ownership information into the digital object. Examples of ownership information may include copyright information, license information, a name and contact information for the original owner, a name and contact information for a buyer or licensee, distribution entities, distribution channels, and any other information associated with a particular digital object. Whenever the ownership of a digital object is in question, the ownership information may be extracted from the digital object and may be used to identify the rightful owner. This may result in improved control and management of content distribution, as well as allow tracing of any unauthorized copies. Where copy protection seems to be difficult to implement, copyright protection protocols based on watermarking and fingerprinting techniques, along with strong cryptography, are becoming more feasible to control the distribution of digital media.

Watermarking may refer to techniques for embedding a digital watermark within a digital object without causing a detectable loss of quality in the digital object to a human viewer. The digital watermark may comprise, for example, a message having a pattern of bits that is inserted into a digital image, such as an audio or video file. The message may include various types of information, such as ownership information or fingerprint execution code, as discussed in more detail below. Unlike printed watermarks, which are intended to be somewhat visible, digital watermarks are designed to be invisible, or in the case of audio clips, inaudible. Moreover, the actual bits representing the watermark should be scattered throughout the file in such a way that they cannot be identified and manipulated. Further, the digital watermark should be robust enough so that it can withstand normal changes to the file, such as reductions from lossy compression algorithms. Watermarking attempts to make the digital watermark appear as noise, that is, random data that exists in most digital files anyway. Watermarking may also be referred to sometimes as “data embedding” and “information hiding.” The embodiments are not limited in this context.

Fingerprinting may refer to techniques for uniquely identifying a digital object using data from the digital object itself. The digital object may comprise, for example, a video file or an audio file. Assume the digital object is an audio file, for example. Audio fingerprinting technology may generate a unique fingerprint for an audio file based on an analysis of the acoustic properties of the audio itself. Each audio fingerprint is unique and can be used to identify a track precisely, regardless of whether any associated text identifiers are present or accurate. For example, a digitized song may be identified whether or not the song title, artist name or other related information is accurate or available, by interpreting audio information audible to humans. Audio fingerprinting extracts a relatively large number of acoustic features from an audio file to create a unique audio fingerprint. Each fingerprint is different and uniquely identifies the specific audio file with a high level of preciseness. Once the audio fingerprint is created, it may be used to search a database matching the audio fingerprint with an audio file, and the audio file to certain ownership information. Similar operations may be performed to create a video fingerprint for a video file. The embodiments are not limited in this context.

Conventional watermarking and fingerprinting techniques taken alone are unsatisfactory for a number of reasons. For example, watermarking techniques may comprise a robust data hiding tool, but do not necessarily uniquely identify the digital object itself as with fingerprinting techniques. Further, audio and video fingerprints typically consume less bandwidth than digital watermarks. Fingerprinting techniques, however, may be limited in the type of information they can convey to a person. For example, an audio fingerprint may not be capable of sending a message not related to the audio file itself. Further, watermarking and fingerprinting techniques may be fairly static, since the encoders and decoders needed to implement a given technique may be difficult to modify without expensive and potentially complicated upgrade operations.

The embodiments attempt to solve these and other problems. In one embodiment, for example, SMM 108 may be arranged to embed a message in a digital object using one or more watermarking techniques. The message may include, among other things, program instructions. Program instructions may include computer code segments comprising words, values and symbols from a predefined computer language that, when placed in combination according to a predefined manner or syntax, cause a processor to perform certain operations. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

In one embodiment, the message may comprise program instructions to implement one or more audio or video fingerprinting operations or techniques. For example, the message may include program instructions compiled to form executable code (“fingerprinting executable code”). The fingerprint executable code may be used to enforce a rights management policy or some viewing criteria that has been set by content server 102 before the content was sent to client device 106, based on a set of rules that was set forth by content server 102 at the time of content purchase or access. Unlike a typical static watermark, content server 102 may dynamically change the enforcement policy and corresponding operations to accomplish this by updating the fingerprint executable code that is embedded along with the watermark. This may occur without necessarily modifying the watermark decoder implemented by client device 106. Rather, the changes to the viewing policy and rights management policy are embedded in the fingerprint executable code. For example, the code may be implemented using Java byte code or some other executable primitives that can be interpreted and executed within client device 106. The embodiments are not limited in this context.

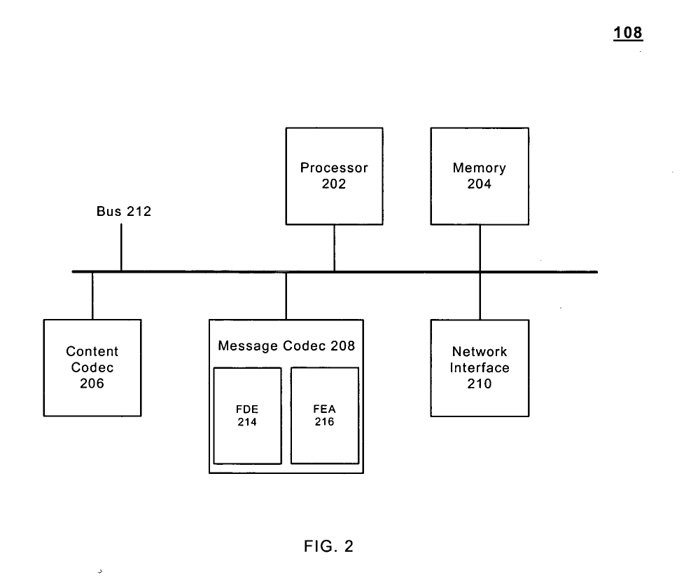

FIG. 2 illustrates a partial block diagram of SMM 108. SMM 108 may represent SMM 108a-b of content server 102 and client device 106, respectively, as described with reference to FIG. 1. As shown in FIG. 2, SMM 108 may comprise multiple elements, such as a processor 202, a memory 204, a content coder/decoder (“codec”) 206, a message codec 208, and a network interface 210, all connected via a bus 212. Some elements may be implemented using, for example, one or more circuits, components, registers, processors, software subroutines, or any combination thereof. Although FIG. 2 shows a limited number of elements, it can be appreciated that more or less elements may be used in SMM 108 as desired for a given implementation. The embodiments are not limited in this context.

In one embodiment, SMM 108 may include processor 202. Processor 202 may be implemented as a general purpose processor, such as a processor made by Intel® Corporation, for example. Processor 202 may also comprise a dedicated processor, such as a controller, microcontroller, embedded processor, a digital signal processor (DSP), a network processor, an I/O processor, and so forth. The embodiments are not limited in this context.

In one embodiment, SMM 108 may include memory 204. Memory 204 may comprise any machine-readable media. Some examples of machine-readable media include, but are not necessarily limited to, read-only memory (ROM), random-access memory (RAM), dynamic RAM (DRAM), double DRAM (DDRAM), synchronous RAM (SRAM), programmable ROM, erasable programmable ROM, electronically erasable programmable ROM, flash memory, a polymer memory such as ferroelectric polymer memory, an ovonic memory, magnetic disk (e.g., floppy disk and hard drive), optical disk (e.g., CD-ROM and DVD), and so forth. The embodiments are not limited in this context.

In one embodiment, SMM 108 may include network interface 210. Network interface 210 may comprise any wired or wireless network interface that may be arranged to operate with any suitable technique for controlling information signals between nodes 102 and 106 via network 104 using a desired set of communications protocols, services or operating procedures. For example, when implemented as part of a wired system, network interface 210 may be arranged to operate in accordance with one or more Ethernet protocols such as Fast Ethernet or Gigabit Ethernet, one or more Internet protocols such as the transport control protocol (TCP)/Internet Protocol (IP), and so forth. Network interface 210 may also include the appropriate physical connectors to connect with a corresponding communications medium for network 104. When implemented as part of a wireless system, network interface 210 may be implemented using a wireless transceiver having an antenna, with the transceiver arranged to operate in accordance with one or more wireless protocols, such as 802.11, 802.16, WAP, and so forth. The embodiments are not limited in this context.

In one embodiment, SMM 108 may include content codec 206. Content codec 206 may be implemented as an audio codec and/or video codec depending on a given system. Content codec 206 is typically implemented with the same or similar features on the transmit side and the receive side, to ensure that the encoded data sent by the transmitting node may be properly received and decoded by the receiving node. The embodiments are not limited in this context.

In one embodiment, for example, content codec 206 may comprise an audio codec to encode and decode audio files in accordance with one or more audio encoding techniques. Examples of audio encoding techniques may include Dolby Digital, MPEG-1, MPEG-1 Layer 3 (MP3), MPEG-2, Linear Pulse Code Modulation (LPCM), Digital Theater System (DTS), Windows Media Audio (WMA), and so forth. The embodiments are not limited in this context.

Content codec 206 may also comprise a video codec to encode and decode video files in accordance with one or more video encoding techniques. Examples of video encoding techniques may include one from a series of MPEG standards, such as MPEG-1, MPEG-2, MPEG-4, MPEG-7, MPEG-21, and so forth. Another example may include Windows Media Video (WMV). The embodiments are not limited in this context.

Content codec 206 may also be implemented as a combination audio and video codec. This may be particularly desirable for a movie. The audio codec may be used to encode the audio information from the movie, and the video codec may be used to encode the video information from the movie. The MPEG series of standards may provide for both audio and video codecs to support such an implementation, for example.

In one embodiment, SMM 108 may include message codec 208. Message codec 208 may include a message encoder to embed a message in one or more video frames received from content codec 206. Message codec 208 may receive the message, for example, from memory 204 or a different device. Message codec 208 may encode one or more video frames with the message to form embedded video frames. Message codec 208 may also include a message decoder to decode or extract the message from the embedded video frames at the receive side.

The message may include static information or dynamic information. The dynamic information may include program instructions, such as fingerprinting executable code. The static information may include, for example, ownership information. The static information may also include data or metadata used by the fingerprinting executable code during execution, or other information directed to managing applications for the fingerprinting executable code. Metadata may comprise data that describes other data. For example, metadata may describe how, when and by whom a particular set of data was collected, and how the data is formatted. Metadata may be used, for example, to understand information stored in data warehouses, XML based applications, and so forth. The embodiments are not limited in this context.

In one embodiment, message codec 208 may include a fingerprint data extractor (FDE) 214. FDE 214 may be arranged to extract a watermark from a digital bit stream, such as an incoming audio/visual stream. FED 214 may extract the watermark using the specific technique implemented by content server 102 to insert the watermark. FED 214 may decompose the extracted watermark into static information and dynamic information. The static information may comprise, for example, ownership information or static metadata for the dynamic information. The dynamic information may comprise, for example, fingerprinting executable code.

In one embodiment, message codec 208 may include a fingerprint execution application (FEA) 216. Once FED 214 receives and verifies the entire fingerprinting executable code, FED 214 may invoke FEA 216 to begin execution of the received fingerprinting executable code. FEA 216 may manage and control execution of the fingerprinting executable code. In the event the program instructions are sent in uncompiled form, for example, FEA 216 may include the appropriate software compiler to compile the program instructions into the appropriate executable form. The fingerprinting executable code may be executed using a dedicated processor assigned for use by message codec 108, a processor available to SMM 108 such as processor 202, or any other processor accessible by client 106. The embodiments are not limited in this context.

By embedding dynamic information such as fingerprint executable code in a watermark, the fingerprinting operations managed by FEA 216 and executed by processor 202 may be changed over time. For this to occur, change events may be separately included as program metadata, along with embedding descriptors. At the receiver, FDE 214 may extract the updated fingerprinting executable code from the compressed video using the associated metadata. FEA 216 may use the updated fingerprinting executable code to compute the appropriate audio or video fingerprint. The computed fingerprint blocks may be returned to content server 102 via an IP back channel (e.g., network 104) for analysis by content server 102. In this manner, playback of premium content in networks can be managed and tracked by content server 102.

As discussed above, the execution environment, embedding descriptors and/or policies can be changed during any given session. The program metadata binds the re-construction at receivers to intended behaviors, which may be set at the server side. For example, the program metadata may include a rights object (RO). The RO may comprise a collection of policies. These policies may be embedded as part of, or separate from, the execution environment. The RO may include, for example, an event descriptor to indicate evaluation of regular expression, regular expression to determine the action, and the desired action specification. The RO may be used to enforce, for example, a particular viewing policy. For example, if the back channel is disabled or if unauthorized playback is detected, then FEA 216 may disable or otherwise prohibit further playback, viewing, or copying of the digital object.

More particularly, the audio and/or video fingerprinting execution environments may include a policy base and a lightweight data structure to capture the key characteristics of the audio and/or video content. The policy base may be implemented, for example, using a triplet. The triplet may include values for an <event>, <rule>, and <action>. The result is a compact signature of the audio and/or video that is being played back. The policy may help ensure that the playback or viewing of the digital object is authorized, while the fingerprint computation generates a signature that is used to measure both qualitative and quantitative consumption metrics. For example, viewing is allowed for licensed devices, paid subscribers, the presence of a working back-channel to report fingerprints, and so forth. If the compressed audio/video bits are transferred to another viewing device without the proper authorization, the video may be modified to appear distorted, for example.

A given policy definition implemented with the fingerprinting executable code may vary according to a given service provider or system design constraints. An example of the type of operations performed by the fingerprinting executable code may include querying back-end servers for past history of content usage on an authorized device prior to allowing playback. Another example may include having the fingerprinting executable code perform an active role in generating any encryption keys needed to access an encrypted digital object, such as an audio or video file. The fingerprint execution code may be arranged to validate a user's credentials, communicate with a back-end server using a proprietary protocol, compute any needed keys, and provide them to the player application. It may be appreciated that these operations are provided by way of example only. The fingerprinting execution code may include any type of fingerprinting operations desired for a given implementation.

In addition to the message having dynamic information to include audio and/or video fingerprinting execution environments, the embedded message may also include digital signatures. Client device 106 may use the digitally signed embedded message to verify the authenticity of the executable before FEA 216 begins execution of the corresponding program instructions. For example, FDE 214 may extract the message from the streaming content using the positional metadata. FEA 216 may verify the digital signature to authenticate the message. FEA 216 may then begin execution of the fingerprint executable code.

The message may be embedded in the content stream using any number of data hiding techniques. For example, message codec 208 may embed the message in the video frames using a watermarking technique. Watermarking may also be referred to as steganography. Steganography is the practice of encoding secret information in a manner that conceals the existence of the information. In digital steganography, a message represented by a stream of bits may be embedded in a cover or host. The cover or host is the medium in which the message is embedded and serves to hide the presence of the message, such as a digital image. This may also be referred to as the message wrapper. The cover and the message do not necessarily need to have homogeneous structures.

Message codec 208 may embed the message in one or more video frames to form embedded video frames. The embedded video frames may be collectively referred to as a “stego-image.” The stego-image should resemble the cover image under casual inspection and analysis.

In addition, message codec 208 may combine cryptographic techniques with steganographic techniques to add an additional layer of security. In cryptography, the structure of a message is changed to render it meaningless and unintelligible unless the decryption key is available. Cryptography makes no attempt to disguise or hide the encoded message. By way of contrast, steganography does not alter the structure of the secret message, but hides it inside a cover. It is possible to combine the techniques by encrypting a message using cryptography and then hiding the encrypted message using steganography. The resulting stego-image can be transmitted without revealing that secret information is being exchanged. Furthermore, even if an attacker were to defeat the steganographic technique and detect the message from the stego-image, he would still require the cryptographic decoding key to decipher the encrypted message. For example, message codec 208 may employ a “stego-key” when forming stego-image. Only recipients who know the corresponding decoding key will be able to extract the message from a stego-image encoded with the stego-key. Recovering the message from a stego-image typically requires only the stego-image itself and a corresponding decoding key if a stego-key was used during the encoding operation. The original cover image may or may not be required. The embodiments are not limited in this context.

The particular watermarking technique selected for message codec 208 may vary according to a number of factors, such as hiding capacity, perceptual transparency, robustness, tamper resistance, and other characteristics. Hiding capacity may refer to the size of information that can be hidden relative to the size of the cover. A larger hiding capacity allows the use of a smaller cover for a message of fixed size, and thus decreases the bandwidth required to transmit the stego-image. Perceptual transparency may refer to the amount of degradation tolerated for the cover. The operations for hiding the message in the cover may necessitate some noise modulation or distortion of the cover image. The embedding should occur without significant degradation or loss of the perceptual quality of the cover. Preserving perceptual transparency in an embedded watermark for copyright protection may be particularly important since the quality and integrity of the original work should be maintained. Robustness may refer to the ability of embedded data to remain intact if the stego-image undergoes transformations, such as linear and non-linear filtering, addition of random noise, sharpening or blurring, scaling and rotations, cropping or decimation, lossy compression, conversion from digital to analog form and then reconversion back to digital form and so forth. Robustness may be particularly important in copyright protection watermarks because pirates will attempt to filter and destroy any watermarks embedded in the stego-image. Tamper-resistance may refer to the difficulty for an attacker to alter or forge a message once it has been embedded in a stego-image, such as a pirate replacing a copyright mark with one claiming legal ownership. Applications that demand high robustness usually also demand a strong degree of tamper resistance. In a copyright protection application, achieving good tamper resistance can be difficult because a copyright is effective for many years and a watermark must remain resistant to tampering even when a pirate attempts to modify it using computing technology decades in the future. Other characteristics to consider may include the computational complexity of encoding and decoding, resistance to collusion attacks where multiple pirates work together to identify and destroy the mark, and so forth. The embodiments are not limited in this context.

Message codec 208 may use one of several different techniques to embed a bit stream representing the message into the image cover. For example, message codec 208 may use Least Significant Bit (LSB) embedding, transform techniques, and techniques that employ perceptual masking. The embodiments, however, are not limited in this context.

In LSB embedding, a digital image may consist of a matrix of color and intensity values. In a typical gray scale image, for example, 8 bits/pixel are used. In a typical full-color image, there are 24 bits/pixel, with 8 bits assigned to each color component. The least complex techniques embed the bits of the message directly into the least-significant bit plane of the cover image in a deterministic sequence. Modulating the least-significant bit does not result in a human-perceptible difference because the amplitude of the change is relatively small. Other techniques attempt to “process” the message with a pseudorandom noise sequence before or during insertion into the cover image. LSB encoding, however, is extremely sensitive to any kind of filtering or manipulation of the stego-image. Scaling, rotation, cropping, addition of noise, or lossy compression to the stego-image is very likely to destroy the message. Furthermore an attacker can potentially remove the message by removing (zeroing) the entire LSB plane with very little change in the perceptual quality of the modified stego-image.

Another class of techniques perform data embedding by modulating coefficients in a transform domain. Examples of transform domains may include the Discrete-Cosine Transform (DCT), Discrete Fourier Transform, Wavelet Transform, and so forth. Transform techniques can offer superior robustness against lossy compression because they are designed to resist or exploit the methods of popular lossy compression algorithms. An example of a transform-based embedding may include modulating DCT coefficients of the stego-image based upon bits of the message and the round-off error during quantization. Transform-based steganography also typically offer increased robustness to scaling and rotations or cropping, depending on the invariant properties of a particular transform.

In general operation, assume client device 106 requests a video file from content server 102. SMM 108a of content server 102 may receive the request, and content codec 206 may begin encoding or compressing video frames from the requested video file in accordance with a video compression technique, such as MPEG-1 or MPEG-2. Message codec 208 may receive a message having static metadata and fingerprinting executable code. Message codec 208 may encode the video frames from content codec 206 with the message to form embedded video frames. Network interface 210 may send the embedded video frames to client device 106 via network 104. SMM 108b of client device 106 may begin receiving the embedded video frames via network interface 210. Content codec 206 may decode or decompress the received video frames, and pass the decoded video frames to message codec 208. FDE 214 of message codec 208 may extract and verify the static information and fingerprinting executable code from the embedded video frames. FDE 214 may send the verified static information and fingerprinting executable code directly to FEA 216, or alternatively, to memory 204. In the latter case, FDE 214 may send a message or signal to FEA 216 to indicate that static information and fingerprinting executable code has been received, verified, and is ready for execution. FEA 216 may initiate execution of the fingerprinting executable code using, for example, processor 202 of client device 106. The fingerprinting executable code may perform audio and/or video operations to implement a given set of policies, such as a security policy, RO policy, and so forth.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

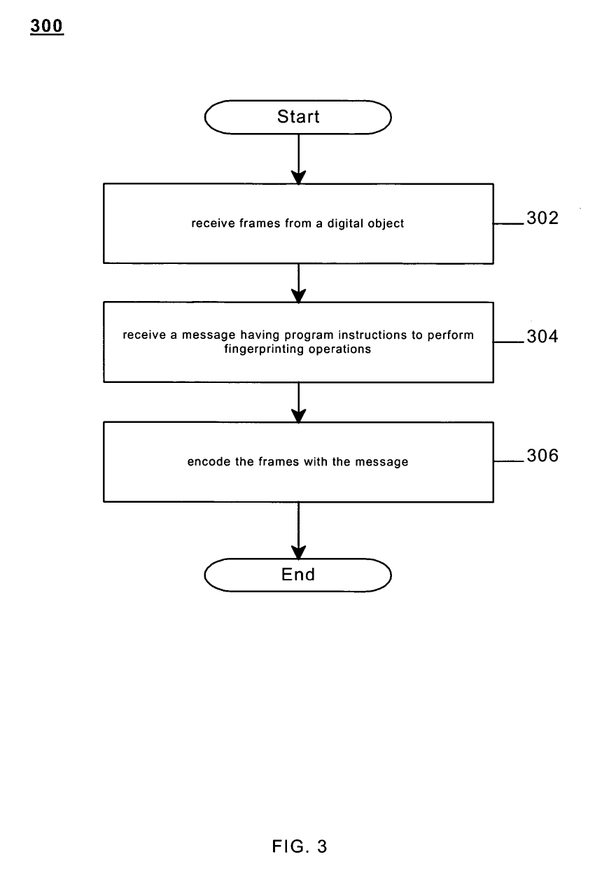

FIG. 3 illustrates a programming logic 300. Programming logic 300 may be representative of the operations executed by one or more systems described herein, such as SMM 108a of content server 102, for example. As shown in programming logic 300, frames from a digital object may be received at block 302. A message may be received having program instructions to perform fingerprinting operations at block 304. The frames may be encoded with the message at block 306.

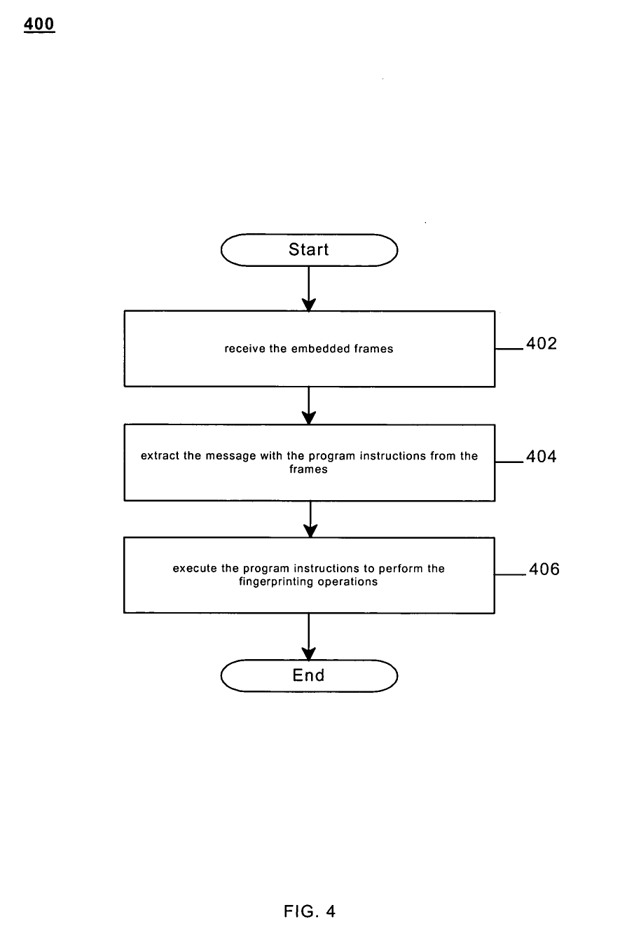

FIG. 4 illustrates a programming logic 400. Programming logic 400 may be representative of the operations executed by one or more systems described herein, such as SMM 108b of client device 106. As shown in programming logic 400, the embedded video frames may be received at block 402. The embedded video frames may be received from, for example, content server 102. The message with the program instructions may be extracted from the frames at block 404. The program instructions may be executed to perform the fingerprinting operations at block 406.

In one embodiment, for example, the digital object may include audio information or video information. The audio or video information may be stored as a file, such as in memory 204, or may comprise streaming or “real time” information from a device, such as a digital camera/recorder (“camcorder), a television broadcast distribution source, a cable distribution source, a satellite distribution source, and other network sources capable of providing audio information, video information, or a combination of audio/video information. The embodiments are not limited in this context.

In one embodiment, for example, the frames may be audio or video frames as defined by one or more MPEG standards. For example, the video frames may comprise I frames having a Y component. In this case, the encoding may be performed by selecting a DCT coefficient for the Y component of each video frame. The selecting may include comparing the DCT coefficient with an average alternating current coefficient for each I frame, and selecting the DCT coefficient if it has a value greater than the average alternating current coefficient. The selected DCT coefficient may be modified to include a message value, such as 0 or 1.

In one embodiment, the embedded video frames may be received. The message may be decoded from the received embedded video frames. The decoding may be performed by retrieving the message value from the DCT coefficient for the Y component for each embedded video frame.

The operation of the above described systems and associated programming logic may be better understood by way of example. Assume client device 106 requests a video file from content server 102. Content codec 206 may encode a video signal in accordance with one in a series of MPEG standards as defined by the ISO/IEC. For example, content decoder 206 may be arranged to encode a video signal in accordance with MPEG-1 and/or MPEG-2.

The basic idea behind MPEG video compression is to remove spatial redundancy within a video frame and temporal redundancy between video frames. DCT-based compression is used to reduce spatial redundancy. Motion compensation is used to exploit temporal redundancy. The images in a video stream usually do not change much within small time intervals. The idea of motion compensation is to encode a video frame based on other video frames temporally close to it.

A video stream may comprise a sequence of video frames. Each frame is a still image. A video player displays one frame after another, usually at a rate close to 30 frames per second (e.g., 23.976, 24, 25, 29.97, and 30). Frames are digitized in a standard Red Green Blue (RGB) format, 24 bits per pixel, with 8 bits each for red, green, and blue. The MPEG-1 algorithm operates on images represented in YUV color space (Y Cr Cb). If an image is stored in RGB format, it must first be converted to YUV format. In YUV format, images are also represented in 24 bits per pixel, with 8 bits for the luminance information (Y), and 8 bits each for the two chrominance information U and V. The YUV format is subsampled. All luminance information is retained. Chrominance information, however, is subsampled 2:1 in both the horizontal and vertical directions. Thus, there are 2 bits each per pixel of U and V information. This subsampling does not drastically affect quality because the eye is more sensitive to luminance than to chrominance information. Subsampling is a lossy step. The 24 bits RGB information is therefore reduced to 12 bits YUV information, which automatically gives 2:1 compression.

Frames are divided into 16×16 pixel macroblocks. Each macroblock consists of four 8×8 luminance blocks and two 8×8 chrominance blocks (1 U and 1 V). Macroblocks are the units for motion-compensated compression. Blocks are used for DCT compression. Frames can be encoded in three types: intra-frames (I-frames), forward predicted frames (P-frames), and bi-directional predicted frames (B-frames). An I-frame is encoded as a single image, with no reference to any past or future frames. The block is first transformed from the spatial domain into a frequency domain using the DCT, which separates the signal into independent frequency bands. Most frequency information is in the upper left corner of the resulting 8×8 block. After this, the data is quantized. Quantization can be thought of as essentially ignoring lower-order bits. Quantization is the only lossy part of the whole compression operation other than subsampling. The resulting data is then run-length encoded in a zig-zag ordering to optimize compression. This zig-zag ordering produces longer runs of zeroes by taking advantage of the fact that there should be little high-frequency information as the encoder zig-zags from the upper left corner towards the lower right corner of the 8×8 block. The coefficient in the upper left corner of the block, called the DC coefficient, is typically encoded relative to the DC coefficient of the previous block, which is sometimes referred to as “DCPM coding”. A P-frame is encoded relative to the past reference frame. A reference frame is a P-frame or I-frame. The past reference frame is the closest preceding reference frame. Each macroblock in a P-frame can be encoded either as an I-macroblock or as a P-macroblock. An I-macroblock is encoded just like a macroblock in an I-frame. A P-macroblock is encoded as a 16×16 area of the past reference frame, plus an error term. To specify the 16×16 area of the reference frame, a motion vector is included. A motion vector (0, 0) means that the 16×16 area is in the same position as the macroblock that is being encoded. Other motion vectors are relative to that position. Motion vectors may include half-pixel values, in which case pixels are averaged. The error term is encoded using the DCT, quantization, and run-length encoding. A macroblock may also be skipped which is equivalent to a (0, 0) vector and an all-zero error term. A B-frame is encoded relative to the past reference frame, the future reference frame, or both frames. The future reference frame is the closest following reference frame (I or P). The encoding for B-frames is similar to P-frames, except that motion vectors may refer to areas in the future reference frames. For macroblocks that use both past and future reference frames, the two 16×16 areas are averaged.

Referring again to the example, content decoder 206 may compress a video signal into video frames in accordance with the MPEG standard. Message codec 208 may receive the compressed video frames from content decoder 206. Message codec 208 may also receive a message from memory 204. The message may comprise, for example, audio or video fingerprint generation source code written in Java, which is compiled into byte code (*.class) and mapped to a linear bit stream. At the execution point, the bit stream is unpacked and executed on client device 106 by message codec 208 of SMM 108b.

To avoid potential color distortion of the stego-image, message codec 208 may select only the Y components of the lead I-frames in the MPEG-2 Group Of Pictures (GOP) structure to carry the hidden message. Further, message codec 208 may skip or omit those I-frames having motion vectors or quantization coefficients larger than a threshold value, such as in type P and B macro-blocks in the I-frame. The message may be embedded in the selected I-frames by modifying the DCT coefficients having values larger than an average alternating current (AC) coefficient for the I-frame. This may reduce the perceptual distortion caused by the embedding operations. Message codec 208 may embed a bit “1” from the message bit stream by changing the value of the selected AC component to the nearest even number. Message codec 208 may embed a bit “0” from the message bit stream by changing the value of the selected AC component to the nearest odd number. The modulated AC component may then be encoded back using variable length encoding.

It is worthy to note that the computation cost for message codec 208 and the corresponding extraction may be low enough to be implemented as a wrapper around a conventional codec. The target execution could either be on the housekeeping processor, such as an XScale® processor, or flexible control elements such as VSparc, around the codec cores. Less than approximately 10% of the modulated bit stream may be different from the un-modulated counterpart due to selection of lead I-frames for the GOP.

SMM 108b of client device 106 may begin receiving the embedded video frames via network interface 210. Content codec 206 may retrieve the message from the embedded video frames. Content codec 206 may send the message to memory 204 to store the message. Processor 202 may execute the program instructions from the message to perform subsequent audio fingerprint operations.

The particular audio or video fingerprint operations implemented for a given system may vary according to the particular target application. For example, assume the rights management policy for viewing a particular video content is such that only licensed devices and a paid subscriber is allowed to view the content. If the compressed audio/video bits are transferred illegally to another viewing device, the video must appear distorted when it is uncompressed and viewed. To enforce this policy, message codec 208 of SMM 108a of content server 102 may actually apply some dynamic distortion to the compressed video. The algorithm for correcting the distortion may be embedded in the fingerprint executable code. In addition, the fingerprint executable code is able to verify the credentials for a user of client device 106 by detecting an identifier from client device 106 and verifying it with content server 102 prior to correcting the distortions in the video.

Assume message codec 208 at client device 106 extracts the message from the received video or audio and presents the message to its execution environment module. The execution module extracts the fingerprint execution code from within the watermark, verifies its integrity, and begins executing the code. The fingerprint execution code may parse the fingerprint metadata that was embedded by content server 102, and extract the user's credentials that need to be verified by client device 106. The fingerprint execution code may check the user's identifier on client device 106 by querying some hardware component that is expected on a licensed client device. The code may also cause the Java or other runtime execution environment to request the user to enter a personal identification number (PIN) or password. The fingerprint execution code may optionally verify the user's credentials with content server 102 over an available backchannel, such as an IP connection to content server 102, or compare the results with user credentials that were included within the watermark. Once the policy set by content server 102 has been verified, the fingerprint execution code may re-order some coefficients of the compressed video or apply other techniques to fix the distortion that was introduced at content server 102, by interacting with message codec 208 within client device 106.

Other examples of fingerprint operations may include the fingerprint execution code updating the message in the compressed content with a user identifier queried from client device 106, such as a network MAC address, to track where that particular piece of content has been transferred and viewed. This would allow a content owner to identify the history associated with the viewing of a particular content by examining the embedded message. In another example, the fingerprint execution code may also play an active part in generating the keys necessary to view a piece of encrypted video. In this case, the player application on client device 106 may extract and run the fingerprint execution code in order to receive the key(s) necessary to descramble and view the content. The fingerprint execution code may validate the user's credentials, communicate with content server 102 using a proprietary protocol, compute the keys and provide them to the player application. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a message encoder to encode frames from a digital object with a message to form embedded frames, said message to comprise program instructions to perform fingerprinting operations.

2. The apparatus of claim 1, wherein said message encoder is to embed said message in said frames as a digital watermark.

3. The apparatus of claim 1, wherein said digital object comprises audio information, and said frames comprise audio frames.

4. The apparatus of claim 1, wherein said digital object comprises video information, and said frames comprise video frames.

5. The apparatus of claim 1, wherein said message includes a digital signature.

6. The apparatus of claim 1, wherein said message to include static metadata to represent a set of policies to be enforced by said program instructions.

7. An apparatus, comprising:
a message decoder to decode a message from embedded frames representing a digital object, said message to comprise program instructions to perform fingerprinting operations.

8. The apparatus of claim 7, wherein said message decoder includes a fingerprint data extractor and a fingerprint execution application, said fingerprint data extractor to extract said message with said program instructions from said embedded frames, and said fingerprint execution application to manage execution of said program instructions to perform said fingerprinting operations.

9. The apparatus of claim 7, wherein said message comprises a digital watermark in said embedded frames.

10. The apparatus of claim 7, wherein said digital object comprises audio information, further including a processor to execute said program instructions to generate an audio fingerprint for said audio information.

11. The apparatus of claim 7, wherein said digital object comprises video information, further including a processor to execute said program instructions to generate a video fingerprint for said video information.

12. The apparatus of claim 7, wherein said message includes a digital signature.

13. The apparatus of claim 7, wherein said message to include static metadata to represent a set of policies to be enforced by said program instructions.

14. A system, comprising:
a content encoder to encode a digital object to form frames of content information;
a message encoder to connect to said content encoder, said message encoder to encode said frames with a message to form embedded frames, said message to comprise program instructions to perform fingerprinting operations; and
a transmitter to connect to said message encoder, said transmitter to transmit said embedded frames.

15. The system of claim 14, further including an antenna to connect to transmitter.

16. The system of claim 14, wherein said digital object comprises audio information or video information.

17. The system of claim 14, wherein said message encoder is to embed said message in said frames as a digital watermark.

18. The system of claim 14, including:
a receiver to receive said embedded frames; and
a message decoder to connect to said receiver, said message decoder to include a fingerprint data extractor and a fingerprint execution application, said fingerprint data extractor to extract said message with said program instructions from said embedded frames, and said fingerprint execution application to manage execution of said program instructions to perform said fingerprinting operations.

19. The system of claim 18, wherein said digital object comprises audio information, further including a processor to execute said program instructions to generate an audio fingerprint for said audio information.

20. The system of claim 18, wherein said digital object comprises video information, further including a processor to execute said program instructions to generate a video fingerprint for said video information.

21. A method, comprising:
receiving frames from a digital object;
receiving a message having program instructions to perform fingerprinting operations; and
encoding said frames with said message.

22. The method of claim 21, including encoding said frames with said message as a digital watermark.

23. The method of claim 21, including generating a digital signature for said digital watermark.

24. The method of claim 21, further comprising:
receiving said embedded frames;
extracting said message with said program instructions from said embedded frames; and
executing said program instructions to perform said fingerprinting operations.

25. The method of claim 24, wherein said digital object comprises audio information, and executing said program instructions generates an audio fingerprint for said audio information.

26. The method of claim 24, wherein said digital object comprises video information, and executing said program instructions generates a video fingerprint for said video information.

27. An article comprising a medium storing instructions that when executed by a processor are operable to receive frames from a digital object, receive a message having program instructions to perform fingerprinting operations, and encode said frames with said message.

28. The article of claim 27, further storing instructions that when executed by a processor are operable to encode said frames with said message as a digital watermark.

29. The article of claim 27, further storing instructions that when executed by a processor are operable to receive said embedded frames, extract said message with said program instructions from said embedded frames, and execute said program instructions to perform said fingerprinting operations.

30. The article of claim 29, further storing instructions that when executed by a processor are operable to execute said program instructions to generate an audio fingerprint or a video fingerprint.
